(19) United States
(12) Patent Application Publication
(10) Pub. No.: US 2024/0215623 A1
(43) Pub. Date: Jul. 4, 2024

(54) TASTE MODIFIER

(71) Applicant: Givaudan SA, VERNIER (CH)

(72) Inventors: Yosuke ONUMA, Cincinnati, OH (US); Feng SHI, Mason, OH (US); Bernard KRANEN, Singapore (SG)

(21) Appl. No.: 18/286,503

(22) PCT Filed: Apr. 11, 2022
(86) PCT No.: PCT/EP2022/059664

§ 371 Date: Oct. 11, 2023

Related U.S. Application Data
(60) Provisional application No. 63/175,314, filed on Apr. 15, 2021.

(51) Int. Cl. A23L 27/00; A23L 2/56

(52) U.S. Cl. CPC A23L 27/88; A23L 2/56

(57) ABSTRACT

A composition including 2,4-dihydroxybenzoic acid and a positive allosteric modulator, a sweetened composition including at least one sweetener and a taste modifier composition including 2,4-dihydroxybenzoic acid and a positive allosteric modulator, and a method of modifying the taste of a sweetened composition by adding to the sweetened composition a taste modifier composition including 2,4-dihydroxybenzoic acid and a positive allosteric modulator.

### TECHNICAL FIELD

The present disclosure relates to taste modifying ingredients and compositions, methods for making taste modifying ingredients and compositions, flavour compositions comprising the taste modifying ingredients, methods of making flavour compositions comprising the taste modifying ingredients, consumables comprising the taste modifying ingredients, methods of making consumables comprising the taste modifying ingredients, methods of modifying the taste of a consumable with the taste modifying ingredients or flavour compositions comprising the taste modifying ingredients, and the use of the taste modifying ingredients or compositions in consumables to improve the sweetness and/or mouthfeel of consumables.

### BACKGROUND

Compounds for modifying the taste of consumable products, that is, products taken orally either for ingestion or spitting out, such as foodstuffs, beverages, confectionery, oral care products and the like are widely used. These compounds do not themselves add flavour to the consumable, but modify the flavour in some desirable way when used in very low concentrations and provide other desired ancillary benefits, such as enhanced sweetness, enhanced mouthfeel, or mask undesirable characteristics of other ingredients present in the consumable.

Sweetness in consumable products is often a desirable characteristic. Traditionally, sweetness has been imparted by the addition of one or more sweeteners, usually low-potency, nutritive sweeteners such as sucrose, fructose, glucose, xylose, arabinose, rhamnose, sugar alcohols such as erythritol, xylitol, mannitol, sorbitol and inositol as well as sugar syrups such as high fructose corn syrup and starch syrup. These sweetness generally deliver considerable sweetness without any undesirable aftertaste.

Sucrose imparts an intense upfront sweetness that is short in time and decreases without any significant off-notes or aftertaste. While the nutritive sweeteners, such as sucrose, impart desired sweetness to a consumable, it is desirable to use reduced amounts of these sweeteners in order to reduce the overall caloric value of the consumable product. It is desirable to provide alternative additives or ingredients that can reduce the caloric value of the consumable product while maintaining the same or a similar sweetness profile (eg, sweetness intensity, aroma and mouthfeel).

There is an ongoing effort in the art to provide reduced sugar consumables that exhibit the sweet taste profile of the full sugar product. Positive allosteric modulators (also known in the art as “PAMs”) of the human sweet taste receptor are compounds that enhance the sweet receptor activity and sweetness taste perception, and have been used for reduced sugar/reduced calorie consumable applications. There are clear disadvantages to the use of PAMs in reduced sugar consumables, namely, the PAMs have a different temporal quality as compared to sugar and they lack a desired sugar-like mouthfeel.

It is therefore still desirable in the art to provide alternative and/or improved taste modifying additives, ingredients, and compositions for addition to sweetened compositions and sweetened consumables to provide a reduced sugar product having a sweet taste profile that closely approximates the sweet taste profile of the full sugar product.

### SUMMARY

According to a first illustrative embodiment, disclosed is a taste modifying ingredient comprising 2,4-dihydroxybenzoic acid and a positive allosteric modulator.

According to a second illustrative embodiment, disclosed is a taste modifying composition comprising 2,4-dihydroxybenzoic acid and a positive allosteric modulator.

According to a third illustrative embodiment, disclosed is a flavour composition comprising (i) at least one sweetener, 2,4-dihydroxybenzoic acid and a positive allosteric modulator, or (ii) at least one sweetener and a taste modifying ingredient or composition comprising 2,4-dihydroxybenzoic acid and a positive allosteric modulator.

According to a fourth illustrative embodiment, disclosed is a consumable comprising a taste modifying ingredient or composition comprising 2,4-dihydroxybenzoic acid and a positive allosteric modulator.

According to a fifth illustrative embodiment, disclosed is a sweetened consumable comprising a consumable base, and (i) at least one sweetener, 2,4-dihydroxybenzoic acid and a positive allosteric modulator, or (ii) at least one sweetener and a taste modifying ingredient or composition comprising 2,4-dihydroxybenzoic acid and a positive allosteric modulator.

According to a sixth illustrative embodiment, disclosed is a beverage product comprising a beverage base and (i) at least one sweetener, 2,4-dihydroxybenzoic acid and a positive allosteric modulator, or (ii) at least one sweetener and a taste modifying ingredient or composition comprising 2,4-dihydroxybenzoic acid and a positive allosteric modulator.

According to a seventh illustrative embodiment, disclosed is a food product comprising a food base and (i) at least one sweetener, 2,4-dihydroxybenzoic acid and a positive allosteric modulator, or (ii) at least one sweetener and a taste modifying ingredient or composition comprising 2,4-dihydroxybenzoic acid and a positive allosteric modulator.

According to an eighth illustrative embodiment, disclosed is a method for making a taste modifying composition comprising combining 2,4-dihydroxybenzoic acid and a positive allosteric modulator.

According to a ninth illustrative embodiment, disclosed is a method for making a flavour composition comprising combining at least one sweetener and (i) at least one sweetener, 2,4-dihydroxybenzoic acid and a positive allosteric modulator, or (ii) at least one sweetener and a taste modifying ingredient or composition comprising 2,4-dihydroxybenzoic acid and a positive allosteric modulator.

According to a tenth illustrative embodiment, disclosed is a method for making a consumable comprising adding to a consumable base a taste modifying ingredient or composition comprising 2,4-dihydroxybenzoic acid and a positive allosteric modulator.

According to an eleventh illustrative embodiment, disclosed is a method for making a sweetened consumable comprising adding to a consumable base at least one sweetener and (i) at least one sweetener, 2,4-dihydroxybenzoic acid and a positive allosteric modulator, or (ii) at least one sweetener and a taste modifying ingredient or composition comprising 2,4-dihydroxybenzoic acid and a positive allosteric modulator.

According a twelfth illustrative embodiment, disclosed is a method of modifying the sweet taste and/or improving the mouthfeel of a consumable, the method comprising adding to said consumable an effective amount of a taste modifying ingredient or composition comprising 2,4-dihydroxybenzoic acid and a positive allosteric modulator to modify and/or improve the mouthfeel of the consumable.

According a thirteenth illustrative embodiment, disclosed is a method of modifying the sweet taste and/or improving the mouthfeel of a consumable, the method comprising adding to said consumable an effective amount of a flavour composition comprising at least one sweetener, 2,4-dihydroxybenzoic acid and a positive allosteric modulator to modify and/or improve the mouthfeel of the consumable.

According to a fourteenth embodiment, disclosed is the use of a taste modifying ingredient or taste modifying composition comprising 2,4-dihydroxybenzoic acid and a positive allosteric modulator to modify the sweet taste and/or improve the mouthfeel of a consumable to which the taste modifying ingredient or taste modifying composition is added.

According to a fifteenth embodiment, disclosed is the use of a flavour composition comprising a flavour composition comprising at least one sweetener, 2,4-dihydroxybenzoic acid and a positive allosteric modulator to modify the sweet taste and/or improve the mouthfeel of a consumable to which the taste modifying ingredient or taste modifying composition is added.

### DETAILED DESCRIPTION

The following text sets forth a broad description of numerous illustrative embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims.

Disclosed is a taste modifying ingredient or composition comprising 2,4-dihydroxybenzoic acid and a positive allosteric modulator of a human sweet taste receptor. According to certain embodiments, the taste modifying ingredient or composition comprising 2,4-dihydroxybenzoic acid and a positive allosteric modulator of a human sweet taste receptor is a sweet taste modifying ingredient or composition. The inventors have surprisingly and unexpectedly discovered that a synergistic relationship exists between 2,4-dihydroxybenzoic acid and PAMs that results in the enhancement of sweetness intensity and modulates sweet quality in sweetened compositions and sweetened consumables.

For the purposes of this specification, the term “taste modifying ingredient or composition” refers to one or more components that improves the sweet taste profile of a reduced sugar sweetened composition or sweetened consumable to which it is added. According to certain illustrative embodiments, without limitation, the taste modifying ingredient or composition may include one or more components in effective amount(s) to enhance sweetness intensity and/or to improve mouthfeel of a reduced sugar sweetened composition or sweetened consumable to which it is added.

According to certain embodiments, the term “taste modifying ingredient or composition” refers to a compound that modifies, enhances, amplifies or potentiates the perception of sweetness of a consumable when the compound is present in the consumable in a concentration at or below the compound's sweetener recognition threshold, i.e., a concentration at which the compound does not contribute any noticeable sweet taste in the absence of the additional sweetener(s). For purposes of this specification, the term “sweetness recognition threshold concentration,” is the lowest known concentration of a compound that is perceivable by the human sense of taste as sweet.

Mouthfeel (or “mouth feel”) refers to the physical sensations experienced or felt in the mouth that are created by food and beverages, or compositions added to food or beverages. Mouthfeel may refer to textures that come into contact with the tongue, roof of the mouth, teeth, gums, or throat. Mouthfeel is considered to be distinct from taste/flavor, but is considered to have an equal or even greater impact on a person's enjoyment or preference for certain foods over others. Typical mouthfeel descriptors used to describe perceived sensations include acidity (metallic, citrusy, bright), density (close, airy), dryness (arid, scorched), graininess (particulate, powdery, dusty, grainy, chalky), gumminess (chewy, tough), hardness (crunchy, soft), heaviness (full, weighty), irritation (prickly, stinging), mouth coating (oily, buttery), roughness (abrasive, textured), slipperiness (slimy, stringy), smoothness (satiny, velvety), uniformity (even, uneven) and viscosity (full-bodied, light-bodied).

Without limitation, and only by way of illustration, the positive allosteric modulator component of the taste modifying ingredient or composition may be selected from any one or more compounds disclosed in WO 2008/154,221, U.S. Patent Application Publication No. U.S. 2014/0235624 A1, U.S. Patent Application Publication No. U.S. 2018/0086751 A1, and U.S. Patent Application Publication No. US 2017/0354175, each of which are incorporated by reference in their respective entireties.

According to certain illustrative embodiments, the positive allosteric modulator component of the taste modifying ingredient or composition is selected from one or more of the following compounds:

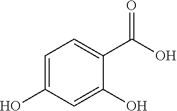 [SMILES: O=C(O)c1ccc(O)cc1O]

2,4-dihydroxyl Benzoic acid (CAS:89-86-1),

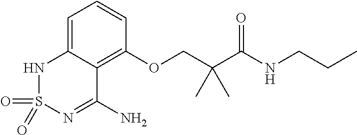 [SMILES: CCCNC(=O)C(C)(C)COc1cccc2c1C(N)=NS(=O)(=O)N2]

Propanamide, 3-[(4-amino-2,2-dioxido-1H-2,1,3-benzothiadiazin-5-yl)oxy]-2,2-dimethyl-N-propyl-(CAS:1093200-92-0),

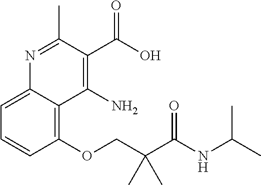 [SMILES: Cc1nc2cccc(OCC(C)(C)C(=O)NC(C)C)c2c(N)c1C(=O)O]

3-Quinolinecarboxylic acid, 4-amino-5-[2,2-dimethyl-3-[(1-methylethyl)amino]-3-oxopropoxy]-2-methyl-(CAS:1359963-68-0),

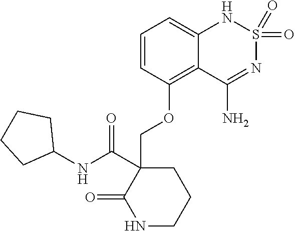 [SMILES: NC1=NS(=O)(=O)Nc2cccc(OCC3(C(=O)NC4CCCC4)CCCNC3=O)c21]

3-Piperidinecarboxamide, 3-[[(4-amino-2,2-dioxido-1H-2,1,3-benzothiadiazin-5-yl)oxy]methyl]-N-cyclopentyl-2-oxo-(CAS:1446687-20-2),

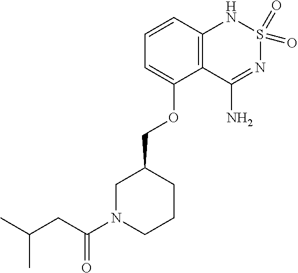 [SMILES: CC(C)CC(=O)N1CCC[C@H](COc2cccc3c2C(N)=NS(=O)(=O)N3)C1]

1-Butanone, 1-[(3S)-3-[[(4-amino-2,2-dioxido-1H-2,1,3-benzothiadiazin-5-yl)oxy]methyl]-1-piperidinyl]-3-methyl-(CAS:1469426-64-9),

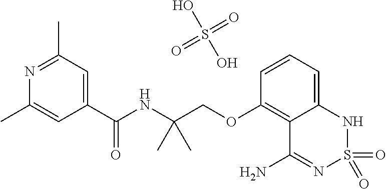

4-Pyridinecarboxamide, N-[2-[(4-amino-2,2-dioxido-1H-2,1,3-benzothiadiazin-5-yl)oxy]-1,1-dimethylethyl]-2,6-dimethyl-sulfamate salt (CAS:2079034-28-7),

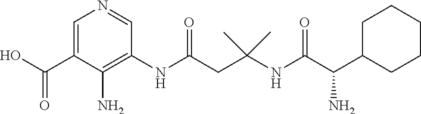 [SMILES: CC(C)(CC(=O)Nc1cncc(C(=O)O)c1N)NC(=O)[C@@H](N)C1CCCCC1]

3-Pyridinecarboxylic acid, 4-amino-5-[[3-[(2S)-2-amino-2-cyclohexylacetyl) amino]-3-methyl-1-oxobutyl]amino]-(CAS: 2242529-79-7),

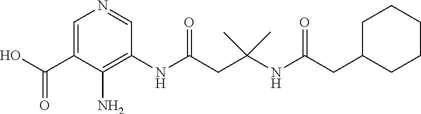 [SMILES: CC(C)(CC(=O)Nc1cncc(C(=O)O)c1N)NC(=O)CC1CCCCC1]

3-Pyridinecarboxylic acid, 4-amino-5-[[3-[(2-cyclohexylacetyl)amino]-3-methyl-1-oxobutyl]amino]-(CAS: 2242529-82-2),
and combinations thereof.

According to certain illustrative embodiments, the positive allosteric modulator component of the taste modifying ingredient or composition is the following compound:

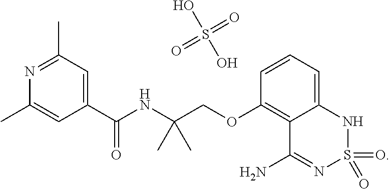

According to certain illustrative embodiments, the positive allosteric modulator component of the taste modifying ingredient or composition is the following compound:

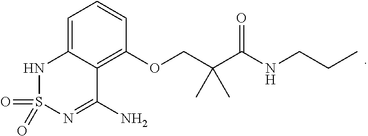 [SMILES: CCCNC(=O)C(C)(C)COc1cccc2c1C(N)=NS(=O)(=O)N2]

According to certain illustrative embodiments, the positive allosteric modulator component of the taste modifying ingredient or composition is the following compound:

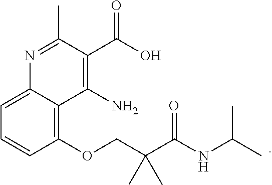 [SMILES: Cc1nc2cccc(OCC(C)(C)C(=O)NC(C)C)c2c(N)c1C(=O)O]

According to certain embodiments, the 2,4-dihydroxybenzoic acid may be present in the taste modifying ingredient or composition in an amount of about 0.1 to about 1000 ppm. According to certain embodiments, the 2,4-dihydroxybenzoic acid may be present in the taste modifying ingredient or composition in an amount of about 0.1 to about 900 ppm, or in an amount of about 0.1 to about 9800 ppm, or in an amount of about 0.1 to about 700 ppm, or in an amount of about 0.1 to about 600 ppm, or in an amount of about 0.1 to about 500 ppm, or in an amount of about 0.1 to about 400 ppm, or in an amount of about 0.1 to about 300 ppm, or in an amount of about 0.1 to about 200 ppm, or in an amount of about 0.1 to about 100 ppm, or in an amount of about 0.1 to about 90 ppm, or in an amount of about 0.1 to about 80 ppm, or in an amount of about 0.1 to about 70 ppm, or in an amount of about 0.1 to about 60 ppm, or in an amount of about 0.1 to about 50 ppm, or in an amount of about 0.1 to about 40 ppm, or in an amount of about 0.1 to about 30 ppm, or in an amount of about 0.1 to about 20 ppm, or in an amount of about 0.1 to about 15 ppm, or in an amount of about 0.1 to about 10 ppm, or in an amount of about 0.1 to about 9 ppm, or in an amount of about 0.1 to about 8 ppm, or in an amount of about 0.1 to about 7 ppm, or in an amount of about 0.1 to about 6 ppm, or in an amount of about 0.1 to about 5 ppm, or in an amount of about 0.1 to about 5 ppm, or in an amount of about 0.1 to about 4 ppm, or in an amount of about 0.1 to about 3 ppm, or in an amount of about 0.1 to about 2 ppm, or in an amount of about 0.1 to about 1 ppm, or in an amount of about 0.1 to about 0.75 ppm, or in an amount of about 0.1 to about 0.4 ppm, or in an amount of about 0.1 to about 0.3 ppm, or in an amount of about 0.1 to about 0.25 ppm, or in an amount of about 0.1 to about 0.2 ppm.

According to certain embodiments, the positive allosteric modulator may be present in the taste modifying ingredient or composition in an amount of about 0.015 to about 100 ppm. According to other embodiments, the positive allosteric modulator may be present in an amount of about 0.015 to about 90 ppm, or in an amount of about 0.015 to about 80 ppm, or in an amount of about 0.015 to about 70 ppm, or in an amount of about 0.015 to about 60 ppm, or in an amount of about 0.015 to about 50 ppm, or in an amount of about 0.015 to about 40 ppm, or in an amount of about 0.015 to about 30 ppm, or in an amount of about 0.015 to about 20 ppm, or in an amount of about 0.015 to about 15 ppm, or in an amount of about 0.015 to about 10 ppm, or in an amount of about 0.015 to about 5 ppm, or in an amount of about 0.015 to about 4 ppm, or in an amount of about 0.015 to about 3 ppm, or in an amount of about 0.015 to about 2 ppm, or in an amount of about 0.015 to about 1.5 ppm, or in an amount of about 0.015 to about 1 ppm, or in an amount of about 0.015 to about 0.75 ppm, or in an amount of about 0.015 to about 0.5 ppm, or in an amount of about 0.015 to about 0.25 ppm, or in an amount of about 0.015 to about 0.125 ppm, or in an amount of about 0.015 to about 0.06 ppm, or in an amount of about 0.015 to about 0.03 ppm, or in an amount of about 0.015 to about 0.025 ppm.

According to certain illustrative embodiments, the composition comprises 2,4-dihydroxybenzoic acid in an amount from about 0.1 to about 1000 ppm and the positive allosteric modulator in an amount from about 0.01 to about 100 ppm.

According to certain illustrative embodiments, the composition comprises 2,4-dihydroxybenzoic acid in an amount from about 0.5 to about 100 ppm and the positive allosteric modulator in an amount from about 0.05 to about 75 ppm.

According to certain illustrative embodiments, the composition comprises 2,4-dihydroxybenzoic acid in an amount from about 0.5 to about 10 ppm and the positive allosteric modulator in an amount from about 0.1 to about 50 ppm.

According to certain illustrative embodiments, the composition comprises 2,4-dihydroxybenzoic acid in an amount from about 1 to about 5 ppm and the positive allosteric modulator in an amount from about 0.1 to about 25 ppm.

The taste modifying ingredient or composition is capable of modifying the sweet taste perception or profile of a composition or consumable containing at least one sweetener compound. According to certain illustrative embodiments, the taste modifying ingredient or composition is capable of modifying the sweet taste perception or profile of a composition or consumable containing at least one caloric/nutritive sweetener compound. Suitable carbohydrate sweeteners are selected from, but not limited to, the group consisting of sucrose, glyceraldehyde, dihydroxyacetone, erythrose, threose, erythrulose, arabinose, lyxose, ribose, xylose, ribulose, xylulose, allose, altrose, galactose, glucose, gulose, idose, mannose, talose, fructose, psicose, sorbose, tagatose, mannoheptulose, sedoheltulose, octolose, fucose, rhamnose, turanose, cellobiose, sialose and combinations thereof. According to other illustrative embodiments, the sweetened composition or sweetened consumable may include an additional sweetener selected from rare sugars selected from sorbose, lyxose, ribulose, xylose, xylulose, D-allose, L-ribose, D-tagatose, L-glucose, L-fucose, L-arabinose, turanose and combinations thereof. In one embodiment, the sweetener is a caloric sweetener or mixture of caloric sweeteners. In another embodiment, the caloric sweetener is selected from sucrose, fructose, glucose, high fructose com/starch syrup, a beet sugar, a cane sugar and combinations thereof.

According to certain illustrative embodiments, the taste modifying ingredient or composition is capable of modifying the sweet taste perception or profile of a composition or consumable containing at least one high intensity sweetener compound. The taste modifying ingredient or composition is capable of modifying the sweet taste perception or profile of a composition or consumable containing, for example, and without limitation, Advantame, Alitame, Aspartame, Hesperetin dihydrochalcone 4′-O-glucoside, Neohesperidin dihydrochalcone, Neotame, Sucralose.

The taste modifying ingredient or composition comprising 2,4-dihydroxybenzoic acid and a positive allosteric modulator may be combined with one or more other components to provide a flavour composition. According to certain illustrative embodiments, the taste modifying ingredient or composition comprising 2,4-dihydroxybenzoic acid and a positive allosteric modulator may be combined with one or more sweeteners to provide a flavour composition. According to further illustrative embodiments, the taste modifying ingredient or composition comprising 2,4-dihydroxybenzoic acid and a positive allosteric modulator may be combined with one or more sweeteners and one or more other components to provide a flavour composition.

Flavour compositions may contain one or more food grade excipient(s). Suitable excipients for flavour compositions are well known in the art and include, for example, without limitation, solvents (including water, alcohol, ethanol, oils, fats, vegetable oil, and miglyol), binders, diluents, disintegranting agents, lubricants, flavouring agents, colouring agents, preservatives, antioxidants, emulsifiers, stabilisers, flavour-enhancers, sweetening agents, anti-caking agents, and the like. Examples of such carriers or diluents for flavours may be found e.g. in “Perfume and Flavour Materials of Natural Origin”, S. Arctander, Ed., Elizabeth, N.J., 1960; in “Perfume and Flavor Chemicals”, S. Arctander, Ed., Vol. I & II, Allured Publishing Corporation, Carol Stream, USA, 1994; in “Flavourings”, E. Ziegler and H. Ziegler (ed.), Wiley-VCH Weinheim, 1998, and “CTFA Cosmetic Ingredient Handbook”, J. M. Nikitakis (ed.), 1st ed., The Cosmetic, Toiletry and Fragrance Association, Inc., Washington, 1988. The flavour compositions may have any suitable form, for example liquid or solid, wet or dried, or in encapsulated form bound to or coated onto carriers/particles or as a powder.

The taste modifying ingredient or composition comprising 2,4-dihydroxybenzoic acid and a positive allosteric modulator, or a flavour composition comprising a flavour component and the taste modifying ingredient or composition comprising 2,4-dihydroxybenzoic acid and a positive allosteric modulator may be included in a consumable. According to certain embodiments, the taste modifying ingredient or composition comprising 2,4-dihydroxybenzoic acid and a positive allosteric modulator, or a flavour composition comprising at least one sweetener and the taste modifying ingredient or composition comprising 2,4-dihydroxybenzoic acid and a positive allosteric modulator may be included in a consumable.

The consumable may include a base. As used herein, the term “base” refers to all the ingredients necessary for the consumable, apart from the taste modifying ingredient or composition, or a flavour composition comprising a flavour component (such as at least one sweetener) and the taste modifying ingredient or composition. The base will naturally vary in both nature and proportion, depending on the nature and use of the consumable, but they are all well known to the art and may be used in art-recognized proportions. The formulation of such a base for every conceivable purpose is therefore within the ordinary skill of the art.

Without limitation, and only by way of illustration, suitable bases may include, anti-caking agents, anti-foaming agents, anti-oxidants, binders, colourants, diluents, disintegrants, emulsifiers, encapsulating agents or formulations, enzymes, fats, flavour-enhancers, flavouring agents, gums, polysaccharides, preservatives, proteins, solubilisers, solvents, stabilisers, sugar-derivatives, surfactants, sweetening agents, vitamins, waxes, and the like. Solvents which may be used are known to those skilled in the art and include e.g. water, ethanol, ethylene glycol, propylene glycol, glycerine and triacetin. Encapsulants and gums include maltodextrin, gum arabic, alginates, gelatine, modified starch, other polysaccharides, and proteins. Examples of excipients, carriers, diluents or solvents for flavor compounds may be found e.g. in “Perfume and Flavour Materials of Natural Origin”, S. Arctander, Ed., Elizabeth, N.J., 1960; in “Perfume and Flavour Chemicals”, S. Arctander, Ed., Vol. I & II, Allured Publishing Corporation, Carol Stream, USA, 1994; in “Flavourings”, E. Ziegler and H. Ziegler (ed.), Wiley-VCH Weinheim, 1998, and “CTFA Cosmetic Ingredient Handbook”, J. M. Nikitakis (ed.), 1st ed., The Cosmetic, Toiletry and Fragrance Association, Inc., Washington, 1988.

Ancillary ingredients may be present to provide other benefits such as enhanced stability, ease of incorporation into a consumable and enhanced nutritional value. Non-limiting typical examples of such ancillary ingredients include stabilizers, emulsifiers, preservatives, gums, starches, dextrins, vitamins and minerals, functional ingredients, salts, antioxidants, and polyunsaturated fatty acids. Particular examples are emulsifiers and carriers, useful in spray drying processes. Non-limiting examples of these are modified starches, such as Capsul™, and maltodextrin.

According to the present disclosure, the term “consumable” refers to products for consumption by a subject, typically via the oral cavity (although consumption may occur via non-oral means such as inhalation), for at least one of the purposes of enjoyment, nourishment, or health and wellness benefits. Consumables may be present in any form including, but not limited to, liquids, solids, semi-solids, tablets, capsules, lozenges, strips, powders, gels, gums, pastes, slurries, solutions, suspensions, syrups, aerosols and sprays. The term also refers to, for example, dietary and nutritional, and health and wellness supplements. Consumables also include compositions that are placed within the oral cavity for a period of time before being discarded but not swallowed. It may be placed in the mouth before being consumed, or it may be held in the mouth for a period of time before being discarded.

Consumables include, but are not limited to, comestibles of all kinds, confectionery products, baked products, sweet products, savoury products, fermented products, dairy products, non-dairy products, beverages, nutraceuticals and pharmaceuticals.

According to certain embodiments, beverages include carbonated beverages. Carbonated beverages include all beverages and drinks that include carbon dioxide dissolved in a liquid, such as water. Without limitation, carbonated beverages include bubbly waters, fizzy waters, champagne, carbonated sodas, carbonated soft drinks, (eg, Coca-Cola, Pepsi, Dr. Pepper, Mountain Dew, Sprite, 7-Up, etc, . . . ), carbonated fruit drinks, carbonated juices, carbonated coffees, carbonated energy drinks, flavored sparkling waters, flavored seltzer waters, carbonated mineral waters, sparkling teas, sparkling tonics, and sparkling wines.

Exemplary dairy products include, but are not limited to, cheese, cheese sauces, cheese-based products, ice cream, impulse ice cream, single portion dairy ice cream, single portion water ice cream, multi-pack dairy ice cream, multi-pack water ice cream, take-home ice cream, take-home dairy ice cream, ice cream desserts, bulk ice cream, take-home water ice cream, frozen yoghurt, artisanal ice cream, milk, fresh/pasteurized milk, full fat fresh/pasteurized milk, semi skimmed fresh/pasteurized milk, long-life/uht milk, full fat long life/uht milk, semi skimmed long life/uht milk, fat-free long life/uht milk, goat milk, condensed/evaporated milk, plain condensed/evaporated milk, flavoured, functional and other condensed milk, flavoured milk drinks, dairy only flavoured milk drinks, flavoured milk drinks with fruit juice, soy milk, sour milk drinks, fermented dairy drinks, coffee whiteners, powder milk, flavoured powder milk drinks, cream, yoghurt, plain/natural yoghurt, flavoured yoghurt, fruited yoghurt, probiotic yoghurt, drinking yoghurt, regular drinking yoghurt, probiotic drinking yoghurt, chilled and shelf-stable desserts, dairy-based desserts, and soy-based desserts.

According to certain embodiments, the taste modifying ingredient or composition, or a flavour composition containing the same, may be incorporated in consumables comprising a non-animal derived protein, such as plant protein. Exemplary plant proteins include soy protein and pea protein. As used herein, soy includes all consumables containing soy in any form, including soybean oil used either alone, in combination, for example as a nutraceutical, or as a medicament, soy bean curd, soy milk, soy butter or soy paste. The plant protein may comprise algae (such as spirulina), beans (such as black beans, canelli beans, kidney beans, lentil beans, lima beans, pinto beans, soy beans, white beans), broccoli, edamame, mycoprotein, nuts (such as almonds, brazil nuts, cashews, peanuts, pecans, hazelnuts, pine nuts, walnuts), peas (such as black eyed peas, chickpeas, green peas), potatoes, oatmeal, seeds (such as chia, flax, hemp, pumpkin, sesame, sunflower), seitan (i.e., wheat gluten-based), tempeh, tofu, and mixtures thereof. According to certain embodiments, the plant protein is a potato-derived protein. In another embodiment, the non-animal protein is selected from one or more of grain, legume, seed, nut, algal, mycoprotein, fungal protein, insect-derived protein and leaf protein.

The taste modifying ingredient or composition, or flavour composition containing the same, may be included in a wide variety of bakery doughs. Illustrative bakery doughs include, but are not limited to, muffins (e.g., English muffins), crackers (e.g., salted crackers, baked crackers, graham crackers, etc.), rolls (e.g., soft rolls, dinner rolls, crescent rolls), biscuits (e.g., buttermilk biscuits, cobbler biscuits), pie crusts, breads (e.g., focaccia, bruschetta, sourdough breads, soda breads, breadsticks, corn bread, etc.), pizza doughs, bagels, and the like.

The taste modifying ingredient or composition, or flavor composition containing the same, may also be included in sweet bakery doughs. Illustrative sweet bakery doughs include, but are not limited to, sweet bakery doughs that are used to prepare, brownies, cookies, muffins, turnovers, doughnuts, cakes, pastries, pies, scones, and the like.

The taste modifier composition may also be used to prepared consumable sweet food products. Without limitation, and only by way of illustration, sweet products include breakfast cereals, ready-to-eat (“rte”) cereals, family breakfast cereals, flakes, muesli, other rte cereals, children's breakfast cereals, and hot cereals.

The taste modifying ingredient or composition, or flavour composition containing the same, may be used in oral care and oral hygiene products. “Oral care” or “oral hygiene” products may include any product that is applied to the oral cavity for the purposes of cleaning, freshening, healing, deodorizing the oral cavity or any part thereof. Without limitation, and only by way of illustration, such oral care and oral hygiene compositions include, toothpastes, tooth gels, tooth powders, tooth whitening products, mouth rinses, mouthwashes, gargle compositions, lozenges, dental floss, tooth picks, anti-plaque and anti-gingivitis compositions, throat lozenges, throat drops, compositions for treatment of nasal symptoms, cold symptoms, and for cold relief.

### EXAMPLES

The following examples are given solely for the purpose of illustration and are not to be construed as limitations of the present invention, as many variations of the invention are possible without departing from the spirit and scope of the present disclosure.

For purposes of the following Examples and Tables the positive allosteric modulators are 5 represented by the following compounds:

PAM 1 is represented by the following compound:

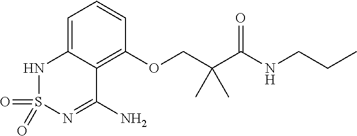 [SMILES: CCCNC(=O)C(C)(C)COc1cccc2c1C(N)=NS(=O)(=O)N2]

PAM 2 is represented by the following compound:

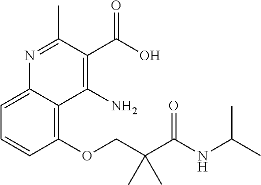 [SMILES: Cc1nc2cccc(OCC(C)(C)C(=O)NC(C)C)c2c(N)c1C(=O)O]

PAM 3 is represented by the following compound:

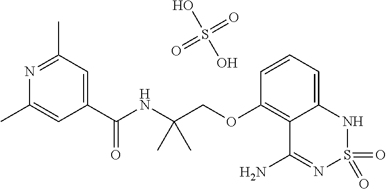

PAM 4 is represented by the following compound:

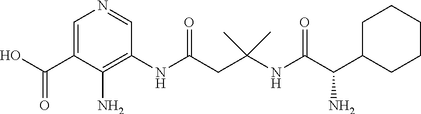 [SMILES: CC(C)(CC(=O)Nc1cncc(C(=O)O)c1N)NC(=O)[C@@H](N)C1CCCCC1]

PAM 5 is represented by the following compound:

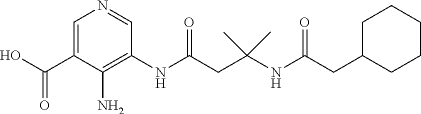 [SMILES: CC(C)(CC(=O)Nc1cncc(C(=O)O)c1N)NC(=O)CC1CCCCC1]

### Comparative Examples 1-1 Through 1-7

Sucrose solutions comprising 1%, 3%, 5%, 7%, or 9% sucrose and 0.05% citric acid in water were prepared. Either 5 ppm or 10 ppm of 2,4-dihydroxybenzoic acid was added to each solution. Each solution was evaluated for the effect of 2,4-dihydroxybenzoic acid on sweetness enhancement. The results are reported in Table 1.

TABLE 1

| | | | | | | | Sucrose | Sucrose |
|---|---|---|---|---|---|---|---|---|
| | | | | | Sucrose | Sucrose | equivalent | equivalent |
| | | | | | equivalent | equivalent | sweetness | sweetness |
| | Dosage of | | | Dosage | sweetness | sweetness | enhancement | enhancement |
| Sample | 2,4-DBA | | PAM | of PAM | w/o PAM | w/PAM | total | of 2,4-DBA |
| C1-1 | 5 | ppm | — | — | 1.0 | 1.0 | 0.0 | 0.0 |
| C1-2 | 5 | ppm | — | — | 3.0 | 3.2 | 0.2 | 0.2 |
| C1-3 | 5 | ppm | — | — | 5.0 | 5.4 | 0.4 | 0.4 |
| C1-4 | 10 | ppm | — | — | 5.0 | 5.4 | 0.4 | 0.4 |
| C1-5 | 5 | ppm | — | — | 7.0 | 7.4 | 0.4 | 0.4 |
| C1-6 | 10 | ppm | — | — | 7.0 | 7.4 | 0.4 | 0.4 |
| C1-7 | 5 | ppm | — | — | 9.0 | 9.4 | 0.4 | 0.4 |

### Examples 2-1 Through 2-22

Sucrose solutions comprising 5% sucrose and 0.05% citric acid in water were prepared. 5 ppm of 2,4-dihydroxybenzoic acid and an amount of selected from the range of 0.015625 to 12 ppm of a commercially available positive allosteric modulator were added to each solution. Each solution was evaluated for the synergistic effect of 2,4-dihydroxybenzoic acid and the positive allosteric modulator on sweetness enhancement of the solution and were compared to sucrose solutions containing only a positive allosteric modulator. The results are reported in Table 2.

TABLE 2

| | | | | | | | Sucrose | Synergy |
|---|---|---|---|---|---|---|---|---|
| | | | | | Sucrose | Sucrose | equivalent | sweetness |
| | | | | | equivalent | equivalent | sweetness | enhancement |
| | Dosage of | | Dosage | | sweetness | sweetness | enhancement | of 2,4-DBA |
| | 2,4-DBA | PAM | of PAM | | w/o PAM | w/PAM | total | and PAM |
| C2-1 | — | PAM 1 | 0.015625 | ppm | 5.0 | 5.0 | 0.0 | — |
| 2-2 | 5 ppm | PAM 1 | 0.015625 | ppm | 5.0 | 5.4 | 0.4 | 0.4 |
| C2-3 | — | PAM 1 | 0.03125 | ppm | 5.0 | 5.1 | 0.1 | — |
| 2-4 | 5 ppm | PAM 1 | 0.03125 | ppm | 5.0 | 5.5 | 0.5 | 0.4 |
| C2-5 | — | PAM 1 | 0.0625 | ppm | 5.0 | 5.3 | 0.3 | — |
| 2-6 | 5 ppm | PAM 1 | 0.0625 | ppm | 5.0 | 5.9 | 0.9 | 0.6 |
| C2-7 | — | PAM 1 | 0.125 | ppm | 5.0 | 5.4 | 0.4 | — |
| 2-8 | 5 ppm | PAM 1 | 0.125 | ppm | 5.0 | 6.3 | 1.3 | 0.9 |
| C2-9 | — | PAM 1 | 0.25 | ppm | 5.0 | 5.6 | 0.6 | — |
| 2-10 | 5 ppm | PAM 1 | 0.25 | ppm | 5.0 | 6.5 | 1.5 | 0.9 |
| C2-11 | — | PAM 1 | 0.5 | ppm | 5.0 | 6.0 | 1.0 | — |
| 2-12 | 5 ppm | PAM 1 | 0.5 | ppm | 5.0 | 6.9 | 1.9 | 0.9 |
| C2-13 | — | PAM 1 | 1 | ppm | 5.0 | 6.3 | 1.3 | — |
| 2-14 | 5 ppm | PAM 1 | 1 | ppm | 5.0 | 7.2 | 2.2 | 0.9 |
| C2-15 | — | PAM 1 | 1.5 | ppm | 5.0 | 6.5 | 1.5 | — |
| 2-16 | 5 ppm | PAM 1 | 1.5 | ppm | 5.0 | 7.4 | 2.4 | 0.9 |
| C2-17 | — | PAM 1 | 3 | ppm | 5.0 | 8.4 | 3.4 | — |
| 2-18 | 5 ppm | PAM 1 | 3 | ppm | 5.0 | 9.4 | 4.4 | 1.0 |
| C2-19 | — | PAM 1 | 6 | ppm | 5.0 | 9.6 | 4.6 | — |
| 2-20 | 5 ppm | PAM 1 | 6 | ppm | 5.0 | 10.4 | 5.4 | 0.8 |
| C2-21 | — | PAM 1 | 12 | ppm | 5.0 | 10.6 | 5.6 | — |
| 2-22 | 5 ppm | PAM 1 | 12 | ppm | 5.0 | 10.7 | 5.7 | 0.1 |

Table 2 shows that Inventive Examples 2-10, 2-12,2-14, 2-16,2-18, 2-20, and 2-22 exhibited more upfront sweetness, more sugary mouthfeel, less licorice-like, and less lingering sweetness as compared to Comparative Examples C2-9, C2-11, C2-13, C2-15, C2-17, C-19, and C-21.

### Examples 3-1 Through 3-10

Sucrose solutions comprising 5% sucrose and 0.05% citric acid in water were prepared. 0.005, 0.01, 0.05, 0.5, 5, 10, 25, 50, 500 or 1000 ppm of 2,4-dihydroxybenzoic acid and 3 ppm of a commercially available positive allosteric modulator were added to each solution. Each solution was evaluated for the synergistic effect of 2,4-dihydroxybenzoic acid and the positive allosteric modulator on sweetness enhancement of the solution and were compared to sucrose solutions containing only a positive allosteric modulator. The results are reported in Table 3.

TABLE 3

| | | | | | | | Sucrose | Synergy |
|---|---|---|---|---|---|---|---|---|
| | | | | | Sucrose | Sucrose | equivalent | sweetness |
| | | | | | equivalent | equivalent | sweetness | enhancement |
| | Dosage of | | | Dosage | sweetness | sweetness | enhancement | of 2,4-DBA |
| | 2,4-DBA | | PAM | of PAM | w/o PAM | w/PAM | total | and PAM |
| 3-1 | 0.005 | ppm | PAM 1 | 3 ppm | 5.0 | 8.4 | 3.4 | 0.0 |
| 3-2 | 0.01 | ppm | PAM 1 | 3 ppm | 5.0 | 8.5 | 3.5 | 0.1 |
| 3-3 | 0.05 | ppm | PAM 1 | 3 ppm | 5.0 | 8.5 | 3.5 | 0.1 |
| 3-4 | 0.5 | ppm | PAM 1 | 3 ppm | 5.0 | 9.0 | 4.0 | 0.6 |
| 3-5 | 5 | ppm | PAM 1 | 3 ppm | 5.0 | 9.4 | 4.4 | 1.0 |
| 3-6 | 10 | ppm | PAM 1 | 3 ppm | 5.0 | 9.5 | 4.5 | 1.1 |
| 3-7 | 25 | ppm | PAM 1 | 3 ppm | 5.0 | 9.6 | 4.6 | 1.2 |
| 3-8 | 50 | ppm | PAM 1 | 3 ppm | 5.0 | 9.6 | 4.6 | 1.2 |
| 3-9 | 500 | ppm | PAM 1 | 3 ppm | 5.0 | 9.6 | 4.6 | 1.2 |
| 3-10 | 1000 | ppm | PAM 1 | 3 ppm | 5.0 | 9.4 | 4.4 | 1.0 |

Table 3 shows Inventive Examples 3-3, 3-4, 3-5, 3-6, 3-7, 3-8, and 3-9 exhibited more upfront sweetness, more sugary mouthfeel, less licorice-like, and less lingering sweetness as compared to Comparative Examples C2-17(Table 2).

### Examples 4-1 Through 4-8

Sucrose solutions comprising 5% sucrose and 0.05% citric acid in water were prepared. 5 ppm of 2,4-dihydroxybenzoic acid and a either 5, 6, 10, 20, or 30 ppm of a positive allosteric modulator were added to each solution. Each solution was evaluated for the synergistic effect of 2,4-dihydroxybenzoic acid and the positive allosteric modulator on sweetness enhancement of the solution and were compared to sucrose solutions containing only a positive allosteric modulator. The results are reported in Table 4.

TABLE 4

| | | | | | | | Sucrose | Synergy |
|---|---|---|---|---|---|---|---|---|
| | | | | | Sucrose | Sucrose | equivalent | sweetness |
| | | | | | equivalent | equivalent | sweetness | enhancement |
| | Dosage of | | Dosage | | sweetness | sweetness | enhancement | of 2,4-DBA |
| | 2,4-DBA | PAM | of PAM | | w/o PAM | w/PAM | total | and PAM |
| C4-1 | — | PAM 2 | 5 | ppm | 5.0 | 8.2 | 3.2 | — |
| 4-2 | 5 ppm | PAM 2 | 5 | ppm | 5.0 | 9.3 | 4.3 | 1.1 |
| C4-3 | — | PAM 3 | 6 | ppm | 5.0 | 8.6 | 3.6 | — |
| 4-4 | 5 ppm | PAM 3 | 6 | ppm | 5.0 | 9.4 | 4.4 | 0.8 |
| C4-5 | — | PAM 4 | 10 | ppm | 5.0 | 7.9 | 2.9 | — |
| 4-6 | 5 ppm | PAM 4 | 10 | ppm | 5.0 | 8.8 | 3.8 | 0.9 |
| C4-7 | — | PAM 5 | 10 | ppm | 5.0 | 8.3 | 3.3 | — |
| 4-8 | 5 ppm | PAM 5 | 10 | ppm | 5.0 | 9.2 | 4.2 | 0.9 |

Table 4 shows Inventive Examples 4-2, 4-4, 4-6, and 4-8 exhibited more upfront sweetness, more sugary mouthfeel, less licorice-like, and less lingering sweetness as compared to Comparative Examples C4-1, C4-3, C4-5, and C4-7.

### Examples 5-1 Through 5-7

Sucrose solutions comprising 5% sucrose and 0.05% citric acid in water were prepared. 5 ppm of 2,4-dihydroxybenzoic acid and a either 2 ppm or 3 ppm of a commercially available positive allosteric modulator were added to each solution. Each solution was evaluated for the synergistic effect of 2,4-dihydroxybenzoic acid and the positive allosteric modulator on sweetness enhancement of the solution and were compared to sucrose solutions containing only a positive allosteric modulator. The results are reported in Table 5.

TABLE 5

| | | | | | | Sucrose | Synergy |
|---|---|---|---|---|---|---|---|
| | | | | Sucrose | Sucrose | equivalent | sweetness |
| | | | | equivalent | equivalent | sweetness | enhancement |
| | Dosage of | | Dosage | sweetness | sweetness | enhancement | of 2,4-DBA |
| | 2,4-DBA | PAM | of PAM | w/o PAM | w/PAM | total | and PAM |
| C5-1 | — | PAM 1 | 2 ppm | 5.0 | 7.1 | 2.1 | — |
| C5-2 | — | PAM 2 | 3 ppm | 5.0 | 7.5 | 2.5 | — |
| C5-3 | — | PAM 3 | 3 ppm | 5.0 | 7.9 | 2.9 | — |
| C5-4 | — | PAM 1 | 2 ppm | 5.0 | 8.1 | 3.1 | — |
| | | PAM 3 | 3 ppm | | | | |
| 5-5 | 5 ppm | PAM 1 | 2 ppm | 5.0 | 9.2 | 4.2 | 1.1 |
| | | PAM 3 | 3 ppm | | | | |
| C5-6 | — | PAM 2 | 3 ppm | 5.0 | 8.5 | 3.5 | 0 |
| | | PAM 3 | 3 ppm | | | | |
| 5-7 | 5 ppm | PAM 2 | 3 ppm | 5.0 | 9.5 | 4.5 | 1.0 |
| | | PAM 3 | 3 ppm | | | | |

Table 5 shows Inventive Examples 5-5 and 5-7 exhibited more upfront sweetness, more sugary mouthfeel, less licorice-like, and less lingering sweetness as compared to Comparative Examples C5-4 and C5-6.

### Examples 6-1 Through 6-11

Fructose solutions comprising 5% fructose and 0.05% citric acid in water were prepared. 2,4-dihydroxybenzoic acid and a commercially available positive allosteric modulator were added to each solution. Each solution was evaluated for the synergistic effect of 2,4-dihydroxybenzoic acid and the positive allosteric modulator on sweetness enhancement of the solution. The results are reported in Table 6.

TABLE 6

| | | | | | | | Sucrose | Synergy |
|---|---|---|---|---|---|---|---|---|
| | | | | | Sucrose | Sucrose | equivalent | sweetness |
| | | | | | equivalent | equivalent | sweetness | enhancement |
| | Dosage of | | Dosage | | sweetness | sweetness | enhancement | of 2,4-DBA |
| | 2,4-DBA | PAM | of PAM | | w/o PAM | w/PAM | total | and PAM |
| C6-1 | 5 ppm | — | — | | 6.0 | 6.3 | 0.3 | 0.3 |
| C6-2 | — | PAM 1 | 3 | ppm | 6.0 | 6.5 | 0.5 | — |
| 6-3 | 5 ppm | PAM 1 | 3 | ppm | 6.0 | 7.8 | 1.8 | 1.3 |
| C6-4 | — | PAM 2 | 5 | ppm | 6.0 | 7.2 | 1.2 | — |
| 6-5 | 5 ppm | PAM 2 | 5 | ppm | 6.0 | 8.0 | 2.0 | 0.8 |
| C6-6 | — | PAM 3 | 6 | ppm | 6.0 | 8.1 | 2.1 | — |
| 6-7 | 5 ppm | PAM 3 | 6 | ppm | 6.0 | 8.7 | 2.7 | 0.6 |
| C6-8 | — | PAM 4 | 10 | ppm | 6.0 | 7.0 | 1.0 | — |
| 6-9 | 5 ppm | PAM 4 | 10 | ppm | 6.0 | 7.8 | 1.8 | 0.8 |
| C6-10 | — | PAM 5 | 10 | ppm | 6.0 | 7.2 | 1.2 | — |
| 6-11 | 5 ppm | PAM 5 | 10 | ppm | 6.0 | 7.8 | 1.8 | 0.6 |

Table 6 shows Inventive Examples 6-3, 6-5,6-7, 6-9, and 6-11 exhibited more upfront sweetness, more sugary mouthfeel, less licorice-like, and less lingering sweetness as compared to Comparative Examples C6-2, C6-4, C6-6, C6-8, and C6-10.

### Examples 7-1 Through 7-7

Glucose solutions comprising 5% glucose and 0.05% citric acid in water were prepared. 2,4-dihydroxybenzoic acid and a commercially available positive allosteric modulator were added to each solution. Each solution was evaluated for the synergistic effect of 2,4-dihydroxybenzoic acid and the positive allosteric modulator on sweetness enhancement of the solution. The results are reported in Table 7.

TABLE 7

| | | | | | | Sucrose | Synergy |
|---|---|---|---|---|---|---|---|
| | | | | Sucrose | Sucrose | equivalent | sweetness |
| | | | | equivalent | equivalent | sweetness | enhancement |
| | Dosage of | | Dosage | sweetness | sweetness | enhancement | of 2,4-DBA |
| | 2,4-DBA | PAM | of PAM | w/o PAM | w/PAM | total | and PAM |
| C7-1 | 5 ppm | — | — | 4.0 | 4.4 | 0.4 | 0.4 |
| C7-2 | — | PAM 1 | 3 ppm | 4.0 | 4.6 | 0.6 | — |
| 7-3 | 5 ppm | PAM 1 | 3 ppm | 4.0 | 5.2 | 1.2 | 0.6 |
| C7-4 | — | PAM 2 | 5 ppm | 4.0 | 5.2 | 1.2 | — |
| 7-5 | 5 ppm | PAM 2 | 5 ppm | 4.0 | 5.6 | 1.6 | 0.4 |
| C7-6 | — | PAM 3 | 6 ppm | 4.0 | 6.2 | 2.2 | — |
| 7-7 | 5 ppm | PAM 3 | 6 ppm | 4.0 | 6.6 | 2.6 | 0.4 |

### Examples 8-1 Through 8-7

Solutions comprising 6.5% invert sugar (76 Brix) and 0.05% citric acid in water were prepared. 2,4-dihydroxybenzoic acid and a positive allosteric modulator were added to each solution. Each solution was evaluated for the synergistic effect of 2,4-dihydroxybenzoic acid and the positive allosteric modulator on sweetness enhancement of the solution. The results are reported in Table 8.

TABLE 8

| | | | | | | Sucrose | Synergy |
|---|---|---|---|---|---|---|---|
| | | | | Sucrose | Sucrose | equivalent | sweetness |
| | | | | equivalent | equivalent | sweetness | enhancement |
| | Dosage of | | Dosage | sweetness | sweetness | enhancement | of 2,4-DBA |
| | 2,4-DBA | PAM | of PAM | w/o PAM | w/PAM | total | and PAM |
| C8-1 | 5 ppm | — | — | 5.2 | 5.4 | 0.2 | 0.2 |
| C8-2 | — | PAM 1 | 3 ppm | 5.2 | 7.4 | 2.2 | — |
| 8-3 | 5 ppm | PAM 1 | 3 ppm | 5.2 | 8.5 | 3.3 | 1.1 |
| C8-4 | — | PAM 2 | 5 ppm | 5.2 | 7.6 | 2.4 | — |
| 8-5 | 5 ppm | PAM 2 | 5 ppm | 5.2 | 8.4 | 3.2 | 0.8 |
| C8-6 | — | PAM 3 | 6 ppm | 5.2 | 8.1 | 2.9 | — |
| 8-7 | 5 ppm | PAM 3 | 6 ppm | 5.2 | 9.2 | 4.0 | 1.1 |

Table 8 shows Inventive Examples 8-3, 8-5, and 8-7 exhibited more sugary mouthfeel, less licorice-like, and less lingering sweetness as compared to Comparative Examples C8-2, C8-4, and C8-6.

### Examples 9-1 Through 9-5

Carbonated drinks comprising 5% sucrose, 0.1% lemon-lime flavor and 0.1% citric acid in carbonated water were prepared. 2,4-dihydroxybenzoic acid and a commercially available positive allosteric modulator were added to each solution. Each solution was evaluated for the synergistic effect of 2,4-dihydroxybenzoic acid and the positive allosteric modulator on sweetness enhancement of the solution. The results are reported in Table 9.

TABLE 9

| | | | | | | Sucrose | Synergy |
|---|---|---|---|---|---|---|---|
| | | | | Sucrose | Sucrose | equivalent | sweetness |
| | | | | equivalent | equivalent | sweetness | enhancement |
| | Dosage of | | Dosage | sweetness | sweetness | enhancement | of 2,4-DBA |
| | 2,4-DBA | PAM | of PAM | w/o PAM | w/PAM | total | and PAM |
| C9-1 | 5 ppm | — | — | 5.0 | 5.0 | 0.0 | 0.0 |
| C9-2 | — | PAM 1 | 3 ppm | 5.0 | 7.0 | 2.0 | — |
| 9-3 | 5 ppm | PAM 1 | 3 ppm | 5.0 | 7.6 | 2.6 | 0.6 |
| C9-4 | — | PAM 3 | 6 ppm | 5.0 | 8.0 | 3.0 | — |
| 9-5 | 5 ppm | PAM 3 | 6 ppm | 5.0 | 8.6 | 3.6 | 0.6 |

Table 9 shows Inventive Examples 9-3 and 9-5 exhibited more upfront sweetness, more sugary mouthfeel, less licorice-like, and less lingering sweetness as compared to Comparative Examples C9-2 and C9-4.

### Examples 10-1 Through 10-5

Chocolate milk drinks comprising 60% milk (1% fat), 4% sucrose, 0.7% cocoa powder, 0.1% chocolate flavor and 0.03% carrageenan in water were prepared. 2,4-dihydroxybenzoic acid and a commercially available positive allosteric modulator were added to each solution. Each solution was evaluated for the synergistic effect of 2,4-dihydroxybenzoic acid and the positive allosteric modulator on sweetness enhancement of the solution. The results are reported in Table 10.

TABLE 10

| | | | | | | Sucrose | Synergy |
|---|---|---|---|---|---|---|---|
| | | | | Sucrose | Sucrose | equivalent | sweetness |
| | | | | equivalent | equivalent | sweetness | enhancement |
| | Dosage of | | Dosage | sweetness | sweetness | enhancement | of 2,4-DBA |
| | 2,4-DBA | PAM | of PAM | w/o PAM | w/PAM | total | and PAM |
| C10-1 | 5 ppm | — | — | 4.0 | 4.0 | 0.0 | 0.0 |
| C10-2 | — | PAM 1 | 3 ppm | 4.0 | 7.0 | 3.0 | — |
| 10-3 | 5 ppm | PAM 1 | 3 ppm | 4.0 | 7.6 | 3.6 | 0.6 |
| C10-4 | — | PAM 3 | 6 ppm | 4.0 | 8.4 | 4.4 | — |
| 10-5 | 5 ppm | PAM 3 | 6 ppm | 4.0 | 9.5 | 5.5 | 1.1 |

Table 10 shows Inventive Examples 3 and 5 exhibited more upfront sweetness, more sugary mouthfeel, and less licorice-like as compared to Comparative Examples C2 and C4.

### Examples 11-5 Through 11-5

A strawberry yogurt comprising 5% sucrose and 0.04% strawberry flavor in a full fat yogurt base were prepared. 2,4-dihydroxybenzoic acid and a commercially available positive allosteric modulator were added to each solution. Each solution was evaluated for the synergistic effect of 2,4-dihydroxybenzoic acid and the positive allosteric modulator on sweetness enhancement of the solution. The results are reported in Table 11.

TABLE 11

| | | | | | | Sucrose | Synergy |
|---|---|---|---|---|---|---|---|
| | | | | Sucrose | Sucrose | equivalent | sweetness |
| | | | | equivalent | equivalent | sweetness | enhancement |
| | Dosage of | | Dosage | sweetness | sweetness | enhancement | of 2,4-DBA |
| | 2,4-DBA | PAM | of PAM | w/o PAM | w/PAM | total | and PAM |
| C11-1 | 5 ppm | — | — | 5.0 | 5.5 | 0.5 | 0.5 |
| C11-2 | — | PAM 1 | 3 ppm | 5.0 | 6.6 | 1.6 | — |
| 11-3 | 5 ppm | PAM 1 | 3 ppm | 5.0 | 7.3 | 2.3 | 0.7 |
| C11-4 | — | PAM 3 | 6 ppm | 5.0 | 7.4 | 2.4 | — |
| 11-5 | 5 ppm | PAM 3 | 6 ppm | 5.0 | 8.2 | 3.2 | 0.8 |

Table 11 shows Inventive Examples 11-3 and 11-5 exhibited more upfront sweetness, more sugary mouthfeel, less licorice-like, and less lingering sweetness as compared to Comparative Examples C11-2 and C11-4.

### Examples 12-1 Through 12-5

Pea protein drinks comprising 3% pea protein, 3% sucrose, 0.3% natural vanilla flavor and 0.05 gellan gum in water were prepared. 2,4-dihydroxybenzoic acid and a commercially available positive allosteric modulator were added to each solution. Each solution was evaluated for the synergistic effect of 2,4-dihydroxybenzoic acid and the positive allosteric modulator on sweetness enhancement of the solution. The results are reported in Table 12.

TABLE 12

| | | | | | | Sucrose | Synergy |
|---|---|---|---|---|---|---|---|
| | | | | Sucrose | Sucrose | equivalent | sweetness |
| | | | | equivalent | equivalent | sweetness | enhancement |
| | Dosage of | | Dosage | sweetness | sweetness | enhancement | of 2,4-DBA |
| | 2,4-DBA | PAM | of PAM | w/o PAM | w/PAM | total | and PAM |
| C12-1 | 5 ppm | — | — | 3.0 | 3.6 | 0.6 | 0.6 |
| C12-2 | — | PAM 1 | 3 ppm | 3.0 | 5.0 | 2.0 | — |
| 12-3 | 5 ppm | PAM 1 | 3 ppm | 3.0 | 5.8 | 2.8 | 0.8 |
| C12-4 | — | PAM 3 | 6 ppm | 3.0 | 6.6 | 3.6 | — |
| 12-5 | 5 ppm | PAM 3 | 6 ppm | 3.0 | 7.2 | 4.2 | 0.6 |

Table 12 shows Inventive Examples 12-3 and 12-5 exhibited smoother mouthfeel and less lingering sweetness as compared to Comparative Examples C12-2 and C12-4.

As used in this specification any reference to the phrases “one embodiment” or “an embodiment” means that a particular element, feature, structure, process step, or characteristic described in connection with the embodiment is included in at least one embodiment. The particular element, feature, structure, process step, or characteristic may, in fact, be included in more than one embodiment disclosed herein. Furthermore, the use of the phrase “in one embodiment” in various places in the specification do not necessarily all refer to the same embodiment.

As used in this specification, the terms “comprises,” “comprising,” “contains,” “containing,” “includes,” “including,” “has,” or “having,” are open-ended expressions and are intended to cover methods, processes, steps, products, apparatus, or systems that comprise a recited list of components, elements, and features, and any and all additional components, elements and features that are not expressly recited.

As used in the present specification, the term “or” refers to the use of an inclusive “or” and not to an exclusive “or”. For example, the phrase “A or B” is satisfied by any one of the following: A is present (element or method step) and B is not present (element or method step), A is not present (element or method step) and B is present (element or method step), and both A and B are present (element or process step).

As used in the present specification, “a” or “an” is employed to describe components, elements, features and method/process steps of various illustrative embodiments disclosed herein. The use of “a” or “an” should be interpreted to include one or more than one.

As used in the present specification, any of the terms “preferably,” “commonly,” and “typically” are not intended to, and do not, limit the scope of disclosed methods, processes or techniques. Rather, these terms are merely intended to identify particular aspects of an embodiment or to emphasize alternative or additional features that may or may not be utilized in a particular embodiment.

In the present disclosure, the term “about” used in connection with a value is inclusive of the stated value and has the meaning dictated by the context. For example, it includes at least the degree of error associated with the measurement of the particular value. One of ordinary skill in the art would understand the term “about” is used herein to mean that an amount of “about” of a recited value produces the desired degree of effectiveness in the compositions and/or methods of the present disclosure. One of ordinary skill in the art would further understand that the metes and bounds of “about” with respect to the value of a percentage, amount or quantity of any component in an embodiment can be determined by varying the value, determining the effectiveness of the compositions or methods for each value, and determining the range of values that produce compositions or methods with the desired degree of effectiveness in accordance with the present disclosure.

It should be understood that when a range of values is described in the present disclosure, it is intended that any and every value within the range, including the end points, is to be considered as having been disclosed. For example, “a range of from 50 to 100” of a component is to be read as indicating each and every possible number along the continuum between 50 and 100. It is to be understood that the inventors appreciate and understand that any and all values within the range are to be considered to have been specified, and that the inventors have possession of the entire range and all the values within the range.

While the taste modifying ingredient, composition, flavour composition, sweetened compositions, consumables, and methods of modifying sweet taste perception in sweetened compositions and consumables have been described above in connection with certain illustrative embodiments, it is to be understood that other embodiments may be used or modifications and additions may be made to the described embodiments for performing the same function of the present embodiments without deviating therefrom. Further, all embodiments disclosed are not necessarily in the alternative, as various embodiments of the invention may be combined to provide the desired characteristics. Variations can be made by one having ordinary skill in the art without departing from the spirit and scope of the disclosure. Therefore, the present disclosure should not be limited to any single embodiment, but rather construed in breadth and scope in accordance with the recitation of the attached claims.

1. A composition comprising 2,4-dihydroxybenzoic acid and a positive allosteric modulator.

2. The composition of claim 1, wherein the 2,4-dihydroxybenzoic acid is present in an amount from 0.1 to 1000 ppm and the positive allosteric modulator is present in an amount from 0.01 to 100 ppm.

3. The composition of claim 2, wherein the 2,4-dihydroxybenzoic acid is present in an amount from 0.5 to 100 ppm and the positive allosteric modulator is present in an amount from 0.05 to 75 ppm.

4. The composition of claim 1, wherein the 2,4-dihydroxybenzoic acid is present in an amount from 0.5 to 10 ppm and the positive allosteric modulator is present in an amount from 0.1 to 50 ppm.

5. The composition of claim 1, wherein the 2,4-dihydroxybenzoic acid is present in an amount from 1 to 5 ppm and the positive allosteric modulator is present in an amount from 0.1 to 25 ppm.

6. The composition of claim 1, wherein the positive allosteric modulator is selected from the group consisting of: 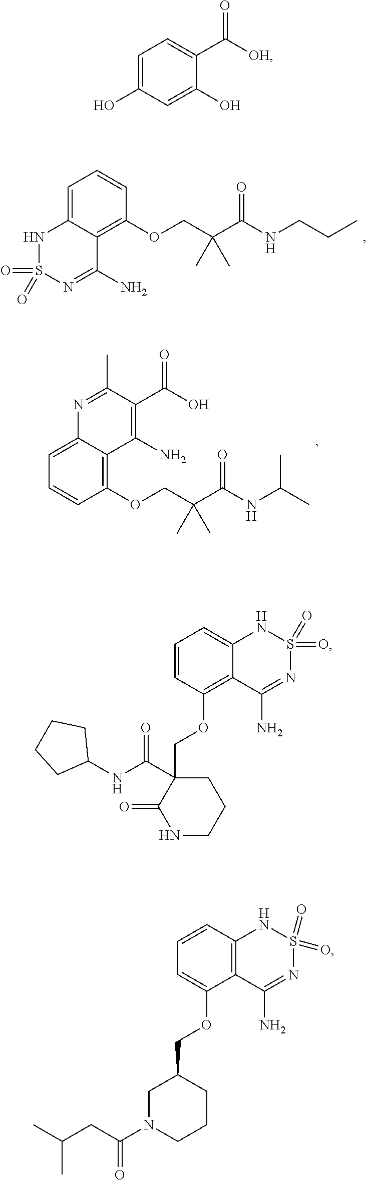 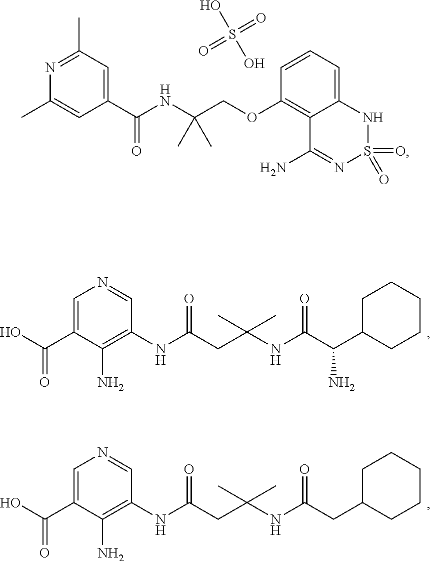
and combinations thereof.

7. The composition of claim 6, wherein the positive allosteric modulator is

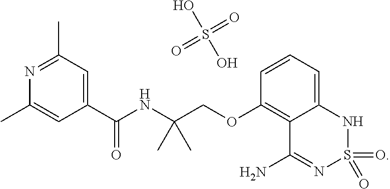

8. The composition of claim 6, wherein the positive allosteric modulator is

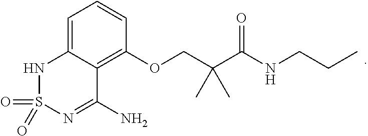 [SMILES: CCCNC(=O)C(C)(C)COc1cccc2c1C(N)=NS(=O)(=O)N2]

9. The composition of claim 6, wherein the positive allosteric modulator is

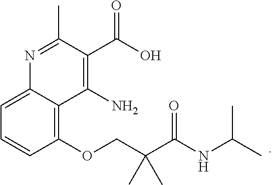 [SMILES: Cc1nc2cccc(OCC(C)(C)C(=O)NC(C)C)c2c(N)c1C(=O)O]

10. The composition of claim 1, further comprising a carrier.

11. A sweetened composition comprising at least one sweetener and taste modifier composition comprising 2,4-dihydroxybenzoic acid and a positive allosteric modulator.

12. The sweetened composition of claim 11, wherein the sweetener is a natural sweetener.

13. The sweetened composition of claim 12, wherein the natural sweetener is selected from fructose and sucrose.

14. The sweetened composition of claim 13, wherein the natural sweetener is sucrose.

15. The sweetened composition of claim 14, wherein sucrose is present in an amount of 1% to 11%, the 2,4-dihydroxybenzoic acid is present in an amount from 0.1 to 1000 ppm and the positive allosteric modulator is present in an amount from 0.01 to 100 ppm.

16. The sweetened composition of claim 15, wherein sucrose is present in an amount of 1.5% to 10%, the 2,4-dihydroxybenzoic acid is present in an amount from 0.5 to 100 ppm and the positive allosteric modulator is present in an amount from 0.05 to 75 ppm.

17. The sweetened composition of claim 16, wherein sucrose is present in an amount of 2% to 9%, the 2,4-dihydroxybenzoic acid is present in an amount from 0.5 to 10 ppm and the positive allosteric modulator is present in an amount from 0.1 to 50 ppm.

18. The sweetened composition of claim 14, wherein sucrose is present in an amount of 2.5% to 8%, the 2,4-dihydroxybenzoic acid is present in an amount from 0.05 to 5 ppm and the positive allosteric modulator is present in an amount from 0.5 to 25 ppm.

19. The sweetened composition of claim 11, wherein the positive allosteric modulator is selected from the group consisting of: 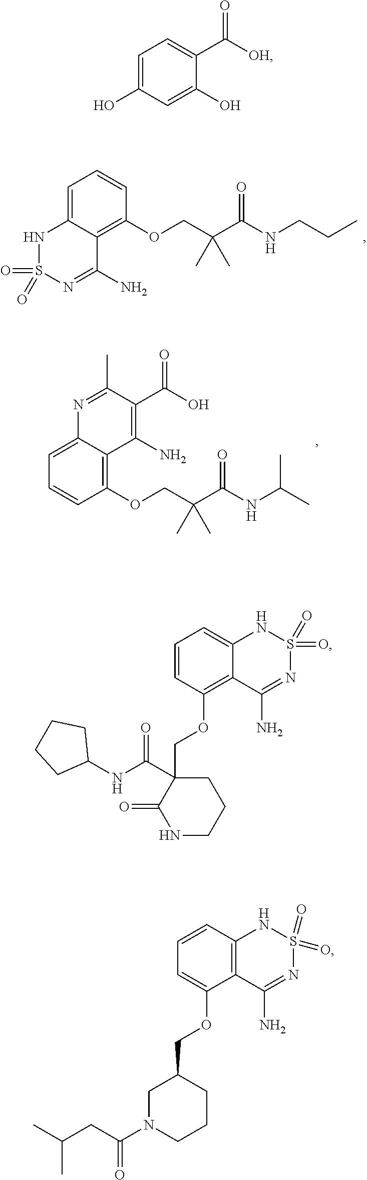 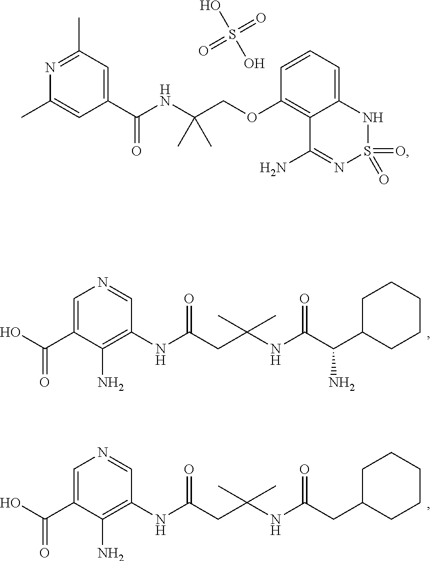
and combinations thereof.

20. (canceled)

21. (canceled)

22. (canceled)

23. A beverage product comprising a beverage base and the taste modifier composition of claim 1.

24. (canceled)

25. (canceled)

26. (canceled)

27. (canceled)
